(19) United States
(12) Patent Application Publication
(10) Pub. No.: US 2015/0292633 A1
(43) Pub. Date: Oct. 15, 2015

(54) INERT LINEAR SHEAR VALVE

(71) Applicant: PARKER-HANNIFIN CORPORATION, Cleveland, OH (US)

(72) Inventors: James Burns, Wilton, NH (US); Joel Verrecchia, Hudson, NH (US); Donald McNeil, Brookline, NH (US)

(73) Assignee: Parker-Hannifin Corporation, Cleveland, OH (US)

(21) Appl. No.: 14/439,928

(22) PCT Filed: Nov. 1, 2013
(86) PCT No.: PCT/US2013/067988

§ 371 Date: Apr. 30, 2015

Related U.S. Application Data
(60) Provisional application No. 61/721,165, filed on Nov. 1, 2012.

(51) Int. Cl. F16K 11/065

(52) U.S. Cl. CPC F16K 11/0655

(57) ABSTRACT

An inert linear shear valve is presented for fluidly coupling at least two flow passages. The linear shear valve includes an actuation device (12) that moves a sliding plate (24) to a position where the at least two flow passage (16,18,20) are fluidly coupled. The sliding plate (24) is biased towards a manifold (14) containing the flow passages (16,18,20) by at least one resilient member (28,30) housed in a carrier (22). The sliding plate (24) has a minimal contact area with the manifold to minimize wear of the sliding plate 24) and the manifold (14).

### RELATED APPLICATIONS

This application claims the benefit of U.S. 61/721,165, which is herein incorporated by reference in its entirety.

### FIELD OF INVENTION

The present invention relates generally to valves, and more particularly to inert linear shear valves.

### BACKGROUND

In clinical diagnostics and analytical chemistry it is necessary to deliver small volumes of various fluids (e.g., samples, calibration fluids, etc.) to measurement devices for diagnostic purposes. Valves (e.g., pinch valves) designed for delivering and switching between small fluid volumes are used to route the correct fluids to the measurement devices in the correct order.

In order to ensure accurate results, the valves used to deliver the fluids to the measurement devices must not carry over samples between measurements. Carry over between measurements may lead to sample contamination and inaccurate diagnostic results. In order to minimize carry over, current valves are repeatedly flushed to remove all traces of the previously transported sample. The more time required to adequately flush a valve reduces the number of samples that can be transported using the valve in a given time period.

Currently, rotary valves, diaphragm isolation valves, and pinch valves are used to deliver fluids to measurement devices in clinical diagnostics and analytical chemistry. Diaphragm isolation valves frequently trap samples in small pockets and, thus, suffer from carry over between measurements. Pinch valves are relatively inexpensive, but begin to degrade after a relatively short period of time. Rotary valves require less flushing and last longer than pinch valves, but are large and expensive.

A small low cost valve is needed that does not suffer from the wear characteristics of pinch valves.

### SUMMARY

The present invention provides a linear shear valve including a ceramic sliding plate having a minimal contact area with a ceramic manifold having two flow passages and an actuation device configured to move the sliding plate to a position in which the sliding plate fluidly connects the two flow passages of the manifold.

According to one aspect of the invention, there is provided an inert linear shear valve (10) including an actuation device (12), a carrier (22), a manifold (14) having a plurality of flow passages (16, 18, 20), a sliding plate (24), and at least one resilient member (28,30). The sliding plate (24) has a notch (26) configured to fluidly couple at least two of the plurality of flow passages (16, 18, 20) when positioned in a first position. The sliding plate (24) is movable between the first position and a second position by the actuation device 12. The at least one resilient member (28, 30), preferably two resilient members (28, 30), are at least partially housed in the carrier (22). The at least one resilient member (28, 30) biases the sliding plate (24) against the manifold (14).

According to another aspect of the invention, there is provided an inert linear shear valve (10) including an actuation device (12), a carrier assembly (21), a manifold assembly (13), a sliding plate (24), and at least one resilient member (28, 30). The carrier assembly (21) includes a carrier housing (22) and a sliding plate (24) fixed in relation to the carrier (22) for translating movement. The manifold assembly (13) includes a manifold housing (15) and a manifold (14) that is retained in the manifold housing (15) and has a plurality of flow passages (16, 18, 20) that open to the surface (60) of the manifold (14) on which the sliding plate (24) moves. The sliding plate (24) has a notch (26) configured to fluidly couple at least two of the plurality of flow passages (16, 18, 20) when positioned in a first position. The sliding plate (24) is movable between the first position and a second position due to movement of the carrier housing (22) by the actuation device 12. The at least one resilient member (28, 30), preferably two resilient members (28, 30), is at least partially housed in the carrier (22). The at least one resilient member (28, 30) biases the sliding plate (24) against the manifold (14).

Alternatively or additionally, the notch (26) is open to an underside of the sliding plate (24) adjacent the manifold (14).

Alternatively or additionally, the actuation device (12) moves the carrier (22) in order to move the sliding plate (24).

Alternatively or additionally, the carrier (22) is disposed between the actuation device (12) and the manifold (14).

Alternatively or additionally, the at least one resilient member (28, 30) compensates for wear of the sliding plate (24) by maintaining the spring force applied to the sliding plate (24) as the sliding plate (24) wears.

Alternatively or additionally, the actuation device (12) is a piezoelectric linear actuator, a linear drive actuator, a solenoid actuator, or a pneumatic drive actuator.

Alternatively or additionally, the manifold (14) is made of a chemically inert ceramic.

Alternatively or additionally, the manifold (14) has a highly polished top surface.

Alternatively or additionally, the sliding plate (24) has a highly polished bottom surface.

Alternatively or additionally, the sliding plate (24) is made of a chemically inert ceramic.

Alternatively or additionally, the manifold (14) has a first flow passage (16), a second flow passage (18), and a third flow passage (20).

Alternatively or additionally, the manifold (14) has a first port (40) connected to the first flow passage (16), a second port (42) connected to the second flow passage (18), and a third port (44) connected to the third flow passage (20).

Alternatively or additionally, the first port (40) and the third port (44) serve as inlet ports and the second port (42) serves as an outlet port.

Alternatively or additionally, in the second position the notch (26) in the sliding plate (24) fluidly couples the second port (42) and the third port (44).

Alternatively or additionally, the first flow passage (16), the second flow passage (18), and the third flow passage (20) are spaced apart such that the first flow passage (16) and the third flow passage (20) cannot be fluidly connected by the notch (26) in the sliding plate (24).

Alternatively or additionally, a width (63) of the notch (26) is approximately equal to or less than a sum of a width of a first adjacent flow passage of the plurality of flow passages (16, 18, 20), a width of a second adjacent flow passage of the plurality of flow passages (16, 18, 20) that is adjacent the first adjacent flow passage, and a distance between the first adjacent flow passage and the second adjacent flow passage at a position adjacent the sliding plate (24).

Alternatively or additionally, when the sliding plate (24) is positioned in a third position none of the plurality of flow passages (16, 18, 20) are fluidly coupled to another of the plurality of flow passages (16, 18, 20).

Alternatively or additionally, the carrier (22) has a bore (32, 34) that houses each respective resilient member (28, 30).

Alternatively or additionally, a device manifold (50) has a plurality of ports (52, 54, 56) that connect to the plurality of ports (40, 42, 44) on the manifold (14).

The foregoing and other features of the invention are hereinafter fully described and particularly pointed out in the claims, the following description and annexed drawings setting forth in detail certain illustrative embodiments of the invention, these embodiments being indicative, however, of but a few of the various ways in which the principles of the invention may be employed.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a perspective view of an exemplary inert linear shear valve.

FIG. 2 is a block diagram of a diagnostic system including the inert linear shear valve.

FIG. 3 is a cross-sectional view of the inert linear shear valve with a sliding plate in a first position.

FIG. 4 is a cross-sectional view of the inert linear shear valve with the sliding plate in a second position.

FIG. 5 is a cross-sectional view of the inert linear shear valve with the sliding plate in a third position.

### DETAILED DESCRIPTION

The present invention provides a linear shear valve for fluidly coupling at least two flow passages. The linear shear valve includes an actuation device that moves a sliding plate to a position where the sliding plate fluidly couples at least two flow passage. The sliding plate is biased towards a manifold containing the flow passages to prevent leakage by at least one resilient member housed in a carrier. The sliding plate has a minimal contact area with the manifold to minimize wear of the sliding plate and the manifold.

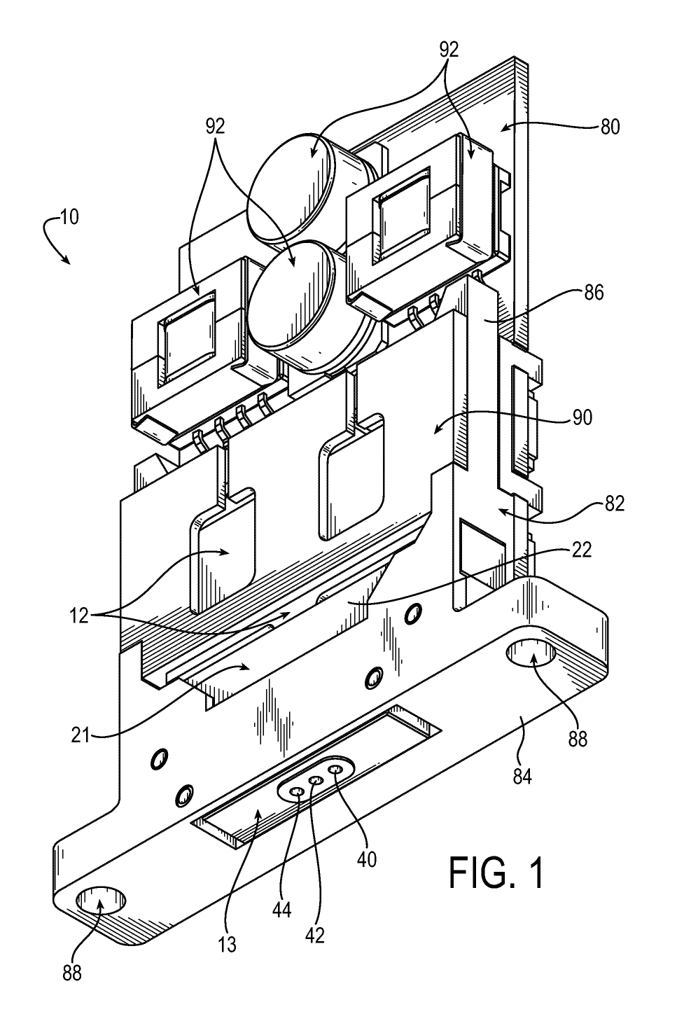

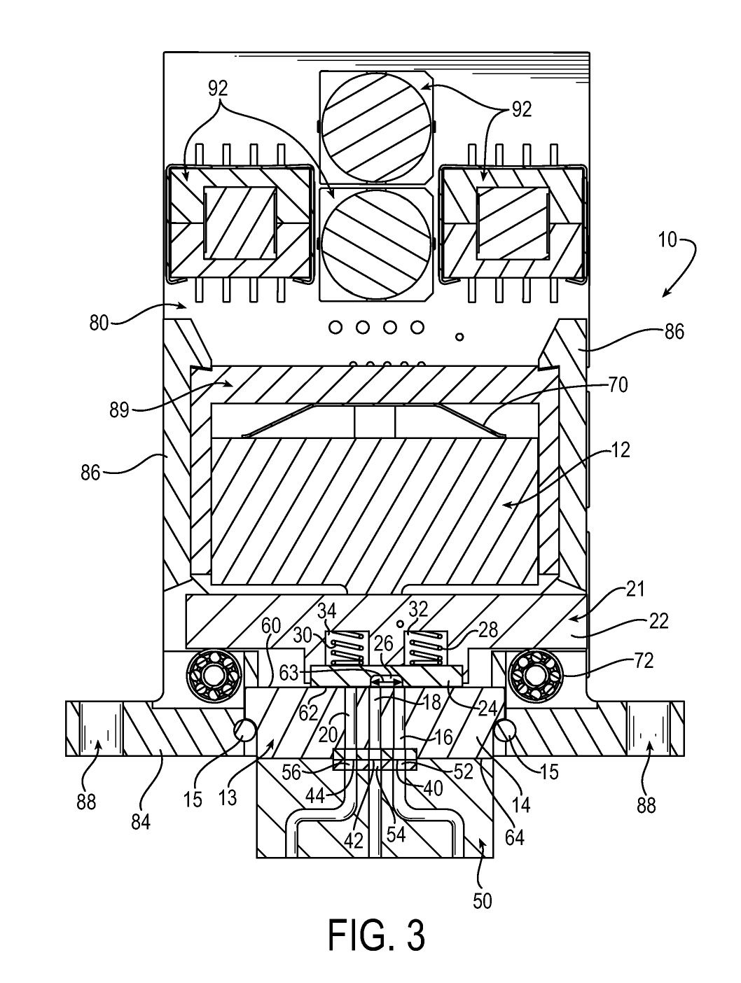

Turning initially to FIGS. 1 and 3, an exemplary inert linear shear valve 10 is shown. The inert linear shear valve 10 includes an actuation device 12, a manifold 14 having a plurality of flow passages 16, 18, 20, a carrier 22, a sliding plate 24, and at least one resilient member 28, 30. As shown in FIG. 3, the sliding plate 24 has a notch 26 configured to fluidly couple at least two of the plurality of flow passages 16, 18, 20 when positioned in a first position. The sliding plate 24 is movable between the first position and a second position by the actuation device 12. In order to maintain the sliding plate 24 in contact with a surface 60 of the manifold 14, the at least one resilient member 28, 30, at least partially housed in the carrier 22, biases the sliding plate 24 against the manifold 14.

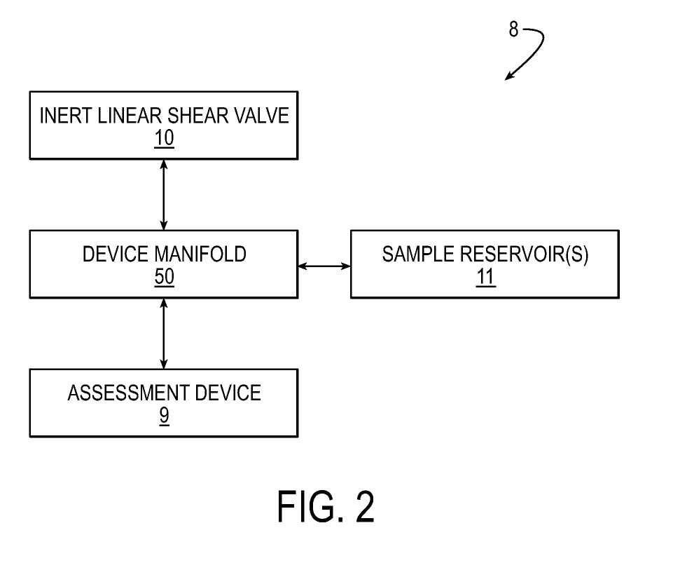

As shown in FIG. 2, the inert linear shear valve 10 may be one component of a diagnostic system 8. For example, the diagnostic system 8 may be a clinical diagnostic system (e.g., an automated blood-analyzing instrument, hematology instrument, fluorescent flow cytometer, etc.) or a chemical diagnostic system (e.g., used in analytical chemistry). The inert linear shear valve 10 may interface with an assessment device 9 via a device manifold 50. As shown in FIG. 3, the device manifold 50 may have a plurality of ports 52, 54, 56 that connect to a plurality of ports 40, 42, 44 on the manifold 14. The plurality of ports 52, 54, 56 on the device manifold 50 may be fluidly connected to the assessment device 9 and sample reservoirs 11. As will be understood by one of ordinary skill in the art, the assessment device 9 may be any suitable device for detecting or measuring a property of a fluid.

The inert linear shear valve 10 may be closed or actuated between fluidly coupling different flow passages 16, 18, 20 by the actuation device 12. As shown in FIG. 3, the actuation device may move the carrier 22 in order to move the sliding plate 24. For example, the actuation device 12 may translate the carrier 22 in a direction generally perpendicular to the primary direction of fluid flow in the flow passages 16, 18, 20 within the manifold 14. The actuation device 12 may be any suitable actuator, such as a piezoelectric linear actuator, a linear drive actuator, a solenoid actuator, or a pneumatic drive actuator. It will be appreciated that the actuator device may be provided in any suitable position, such as above the carrier (shown in FIG. 3), to the side (e.g., the right or left) of the carrier, etc.

The actuation device 12 may receive control signals from the diagnostic system 8 regarding the position of the sliding plate 24. The control signals may be received by a controller (not shown) of the actuator 12 and converted into a drive signal resulting in movement of the sliding plate 24 by the actuation device 12.

The carrier 22 (also referred to herein as a carrier housing) may be a part of a carrier assembly 21. The carrier 22 may be composed of any material suitable for translation by the actuation device 12 and supporting the sliding plate 24 and at least one resilient member 28, 30. For example, the carrier 22 may be composed of aluminum, stainless steel, or ceramic.

The carrier 22 may at least partially house the at least one resilient member 28, 30. For example, as shown in FIGS. 3-5, the resilient members 28, 30 may be housed in bores 32, 34 extending through the carrier. That is, the carrier 22 may have a bore 32, 34 that houses each respective resilient member 28, 30. In the depicted embodiment there are preferably two resilient members 28, 30. The at least one resilient member 28, 30 biases the sliding plate 24 against the manifold 14, e.g., to prevent fluid leakage. The at least one resilient member may be any structure for applying a force to the sliding plate 24, such as coil springs. The at least one resilient member 28, 30 compensates for wear of the sliding plate by maintaining the spring force applied to the sliding plate as the sliding plate wears over time.

The sliding plate 24 may be fixed in relation to the carrier 22 for translating movement. That is, the actuation device 12 may move the sliding plate 24 by moving the carrier 22. As shown in FIGS. 3-5, the carrier 22 may be disposed between the actuation device 12 and the manifold 14. In this way, the sliding plate 24 is movable between the first position and a second position due to movement of the carrier housing 22 by the actuation device 12. As shown in FIGS. 3-5, the carrier 22 may be shaped such that the carrier 22 does not contact the manifold 14. In this way, wearing of the inert linear shear valve 10 is minimized. In the depicted embodiment, the carrier 22 and the sliding plate 24 are shaped such that there is minimal or no movement of the sliding plate 24 relative to the carrier 22 during movement between the first and second positions.

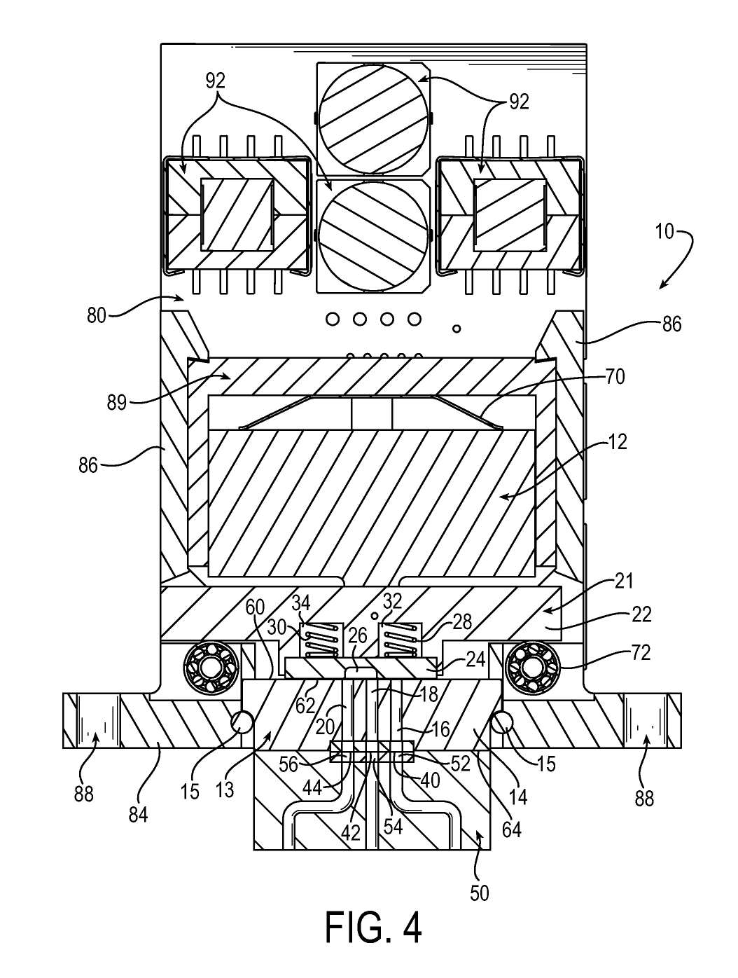

As descried above, the sliding plate 24 is movable between a first position (FIG. 3) and a second position (FIG. 4). In the first position, the notch 26 of the sliding plate 24 fluidly couples at least two of the plurality of flow passages 16, 18, 20 of the manifold 14. In FIGS. 3-5, the notch 26 is open to an underside of the sliding plate 24 adjacent the manifold 14. A bottom surface 62 of the sliding plate 24 may be the only moving component in contact with the top surface 60 of the manifold 14. In this way, wearing of the top surface 60 of the manifold 14 is kept to a minimum. To further reduce wearing of the inert linear shear valve 10, the sliding plate (24) has a highly polished bottom surface 62. The sliding plate 24 may be made of any suitable material. For example, the sliding plate 24 may be made of a chemically inert ceramic. Forming the sliding plate 24 of a chemically inert ceramic improves the wear characteristics of the sliding plate 24, increasing the expected life time of the inert linear shear valve 10.

As will be understood by one of ordinary skill in the art, the notch 26 of the sliding plate 24 may be a recess of various shapes. For example, the notch 26 may take any suitable shape for fluidly connecting at least two of the flow passages. A width 63 of the notch 26 (e.g., the distance between a left edge and a right edge of the notch visible in FIGS. 3-5) may be approximately equal to the distance between the farthest edges between two adjacent flow passages 16, 18, 20. For example, as illustrated in FIG. 3, the width 63 of the notch 26 may be approximately equal to or smaller than the distance between the edge of the second flow passage 18 furthest from the first flow passage 16 (i.e., the left edge of the second flow passage 18) and the edge of the first flow passage 16 furthest from the second flow passage 18 (i.e., the right edge of the first flow passage 16). That is, the width 63 of the notch 26 may be approximately equal to or less than a sum of a width of a first adjacent flow passage (e.g., the first flow passage 16) of the plurality of flow passages 16, 18, 20, a width of a second adjacent flow passage (e.g., the second flow passage 18) of the plurality of flow passages 16, 18, 20 that is adjacent the first adjacent flow passage, and a distance between the first adjacent flow passage and the second adjacent flow passage at a position adjacent the sliding plate 24 (e.g., at or near the surface 60 of the manifold). The edge along which the walls of the notch 26 meet the bottom surface 62 of the sliding plate 24 may be rounded in order to reduce the occurrence of turbulent flow as a fluid passes through the flow passages 16, 18, 20 and enters the notch 26.

The manifold housing has a plurality of flow passages 16, 18, 20. As shown in FIGS. 3-5, the plurality of flow passages 16, 18, 20 may open to the surface 60 of the manifold 14 on which the sliding plate 24 moves. In order to reduce wear of the sliding plate 24 and the manifold surface 60, the manifold 14 has a highly polished top surface and may be made of the same material as the sliding plate 24. For example, the sliding plate 24 and the manifold may both be made of a chemically inert ceramic. The manifold 14 may be retained in a manifold housing 15 that maintains the position of the manifold 14 relative to the device manifold 50 and the inert linear shear valve 10 as a whole. The manifold 14 and the manifold housing 15 may be a part of a manifold assembly 13.

With reference to FIGS. 3-5, the manifold 14 may have a first flow passage 16, a second flow passage 18, and a third flow passage 20. The first flow passage 16, the second flow passage 18, and the third flow passage 20 may be spaced apart such that the first flow passage 16 and the third flow passage 20 cannot be fluidly connected by the notch 26 in the sliding plate 24. A first port 40 may be connected to the first flow passage 16, a second port 42 may be connected to the second flow passage 18, and a third port 44 may be connected to the third flow passage 20. The ports 42, 44, 46 may be located on a bottom surface 64 of the manifold 14 opposite the top surface 62. For example, the first port 40 and the third port 44 may serve as inlet ports and the second port 42 may serve as an outlet port. As will be understood by one of ordinary skill in the art, the ports 42, 44, 46 may alternatively be located on a side surface or other surface of the manifold 14.

Each port 40, 42, 44 of the manifold 22 may be coupled to a respective port 52, 54, 56 on a device manifold 50. For example, a first port 52 of the device manifold 50 may be coupled to the first port 40 of the manifold 22, a second port 54 of the device manifold 50 may be coupled to the second port 42 of the manifold 22, and a third port 56 of the device manifold 50 may be coupled to the third port 44 of the manifold 22. The inert linear shear valve 10 may control passage of fluid through both the first port 52 of the manifold device 50 and the third port 56 of the manifold device 50 into the second port 54 of the manifold device 50.

Turning to FIG. 3, the sliding plate 24 is positioned in a first position. In the first position, the notch 26 in the sliding plate 26 fluidly couples the first flow passage 16 and the second flow passage 18 such that the first port 40 and the second port 42 are fluidly connected. In this way, fluid entering the manifold 14 through the first port 40 exits the manifold through the second port 42. In the depicted embodiment, the third flow passage 20 is blocked by the sliding plate 24.

Turning to FIG. 4, the sliding plate 24 is positioned in a second position. In the second position, the notch 26 in the sliding plate 26 fluidly couples the third flow passage 20 and the second flow passage 18 such that the third port 44 and the second port 42 are fluidly connected. In this way, fluid entering the manifold through the third port 44 exits the manifold through the second port 42. In the depicted embodiment, the first flow passage 16 is blocked by the sliding plate 24.

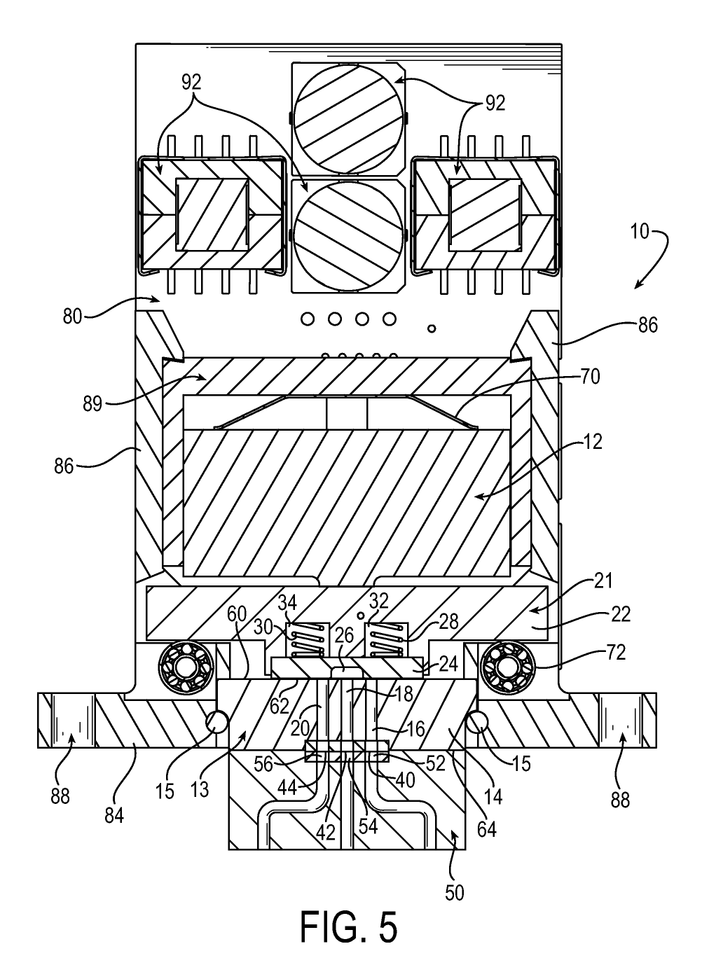

Turning to FIG. 5, the sliding plate 24 is positioned in a third position. When the sliding plate 24 is positioned in a third position none of the plurality of flow passages 16, 18, 20 are fluidly coupled to another of the plurality of flow passages 16, 18, 20. That is, the first flow passage 16, the second flow passage 18, and the third flow passage 20 are all blocked by the sliding plate 24. By blocking flow in all of the flow passage 16, 18, 20, the inert linear shear valve 10 may remove the need for a shut-off valve in the diagnostic system 8.

As will be understood by one of ordinary skill in the art, the flow passages 16, 18, 20 may have any suitable shape for transporting fluid. For example, the flow passages 16, 18, 20 be substantially straight as shown in FIGS. 3-5 or bent (e.g., like the flow passages of the device manifold 50). The flow passages 16, 18, 20 may be configured to be easily cleaned by flushing the flow passages 16, 18, 20 with water or another fluid. That is, the flow passages 16, 18, 20 may have a streamlined shape that minimizes carryover contamination from one use of the inert linear shear valve 10 to the next use. In this regard, the flow passages 16, 18, 20 preferably have a shape in which no portion of the flow passages 16, 18, 20 forms a valley where, in both directions along the flow passage 16, 18, 20, the flow passage 16, 18, 20 slopes upwards. The flow passages 16, 18, 20 may also be shaped such that no portion of the flow passages 16, 18, 20 is horizontal.

The inert linear shear valve 10 is configured to minimize contamination of fluid passing through the valve. Contamination is minimized due to the fact that fluid only contacts the manifold 14 (via the flow passages 16, 18, 20) and the sliding plate 24. Contamination is also minimized due to the shape of the flow passages 16, 18, 20 as described above, which allows for fluids to be flushed from the inert linear shear valve 10. By forming both the sliding plate 24 and the manifold 22 out of a chemically inert ceramic, the inert linear shear valve 10 may transport harsh chemicals (e.g., basic or acidic chemicals) without damaging the inert linear shear valve 10.

The inert linear shear valve 10 may additionally include a biasing member 70 configured to bias the actuation device 12 into contact with the carrier 22. The biasing member 70 may comprise any suitable member for providing a force on the actuation device 12 that biases the actuation device 12 into contact with the carrier 22. For example, the biasing member 70 may comprise a pronged piece of metal as depicted in FIGS. 3-5 or a spring. The force applied by the biasing member 70 may be greater than the force applied by the resilient member 28, 30.

Opposite the biasing member 70, the inert linear shear valve 10 may additionally include a counter biasing member 72. The counter biasing member 72 may support the carrier 22 and prevent the carrier 22 from contacting the surface 60 of the manifold 14. The counter biasing member 72 may comprise any suitable structure for supporting the carrier 22. For example, the counter biasing member 72 may comprise ball bearings surrounding pivot pins as shown in FIGS. 3-5 or a lubricated surface.

As illustrated in FIGS. 3-5, the counter biasing member 72 may be mounted to or supported by a mounting plate 80. The mounting plate 80 may additionally support various other components of the inert linear shear valve 10. For example, the mounting plate 80 may support electronic components 92. The electronic components 92, e.g., may include components necessary to provide power to and control the actuator 12. As will be understood by one of ordinary skill in the art, the electronic components 92 may include any suitable components for providing power to or controlling the actuator (e.g., capacitors, inverters, resistors, etc.).

The mounting plate 80 may be attached to a mounting member 82. The mounting member 82 may include a support base 84 and a support upright 86. As shown in FIGS. 3-5, the support base 84 may support the manifold housing 15. The support base 84 may also include one or more apertures 88 for fixing the inert linear shear valve 10 to an external structure. For example, the support base 84 may be fixed to an external device in order to align the ports 40, 42, 44 of the manifold 13 with the ports 52, 54, 56 of the device manifold 50. The support upright 86 may maintain the position of a bias support 89. The bias support 89 may support the counter biasing member 72 and maintain the position of the actuator 12.

The support upright 86 may also maintain the position of a front plate 90. The front plate 90 may be attached to the mounting member 82. The front plate 90 may maintain the position of the actuator 12. The front plate 90 may be located on the opposite side of the actuator 12 from the mounting plate 80. As shown in FIG.

1, the front plate 90 may also include gaps providing a path for forming electrical connection to the actuator 12. The electrical connection may be used to provide power to the actuator 12. For example, a solder pad may be attached to the surface of the actuator 12 centered below each of the gaps.

The mounting plate 80, mounting member 82, bias support 89, and front plate 90 may be made of any suitable material. For example, the mounting plate 80 may be a printed circuit board (PCB) and the mounting member 82, bias support 89, and front plate 90 may be made of metal, plastic, or a combination thereof.

The inert linear shear valve 10 may additionally include a feedback element (not shown) for providing feedback regarding the position of the sliding plate 24. The feedback element may comprise a linear encoder, an optical sensor, or any other suitable device for providing feedback regarding the position of the sliding plate 24. For example, a linear encoder may provide feedback to the actuation device 12 or a controller (not shown) regarding the position of the carrier 22. Because the sliding plate 24 may be maintained in a fixed location relative to the carrier 22, the position of the sliding plate 24 may be determined based on the position of the carrier 22.

Alternatively, as opposed to a feedback element, carriage movement may be mechanically constrained by one or more mechanical stops. For example, a mechanical stop on one side along the direction of movement of the sliding plate may comprise a first stop. Additionally, a mechanical stop on the opposite side from the first stop along the direction of movement of the sliding plate may comprise a second stop. The carrier 22 may be mechanically constrained from moving beyond the first stop and the second stop. When stopped by the first stop, the carrier 22 may be positioned such that the sliding plate 24 is located at the first position. Similarly, when stopped by the second stop, the carrier 22 may be positioned such that the sliding plate 24 is located at the second position.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

The invention can also be described as set forth in one or more of the following paragraphs:

A. Alternatively or additionally, the at least one resilient member (28, 30) biases the sliding plate (24) against the manifold (14) to prevent fluid leakage.

B. Alternatively or additionally, the at least one resilient member (28, 30) is a coil spring.

C. Alternatively or additionally, the flow passages (16, 18, 20) are straight or bent flow passages (16, 18, 20).

What is claimed is:

1. An inert linear shear valve (10) including:
an actuation device (12);
a carrier (22);
a manifold (14) having a plurality of flow passages (16, 18, 20);
a sliding plate (24) having a notch (26) configured to fluidly couple at least two of the plurality of flow passages (16, 18, 20) when positioned in a first position, the sliding plate (24) movable between the first position and a second position by the actuation device 12; and
at least one resilient member (28, 30), preferably two resilient members (28, 30), at least partially housed in the carrier (22), the at least one resilient member (28, 30) biasing the sliding plate (24) against the manifold (14).

2. An inert linear shear valve (10) including:
an actuation device (12);
a carrier assembly (21) including a carrier housing (22) and a sliding plate (24) fixed in relation to the carrier (22) for translating movement;
a manifold assembly (13) including a manifold housing (15) and a manifold (14) that is retained in the manifold housing (15) and has a plurality of flow passages (16, 18, 20) that open to the surface (60) of the manifold (14) on which the sliding plate (24) moves;
the sliding plate (24) having a notch (26) configured to fluidly couple at least two of the plurality of flow passages (16, 18, 20) when positioned in a first position, the sliding plate (24) movable between the first position and a second position due to movement of the carrier housing (22) by the actuation device 12; and
at least one resilient member (28, 30), preferably two resilient members (28, 30), at least partially housed in the carrier (22), the at least one resilient member (28, 30) biasing the sliding plate (24) against the manifold (14).

3. The inert linear shear valve (10) according to any preceding claim, wherein the notch (26) is open to an underside of the sliding plate (24) adjacent the manifold (14).

4. The inert linear shear valve (10) according to any preceding claim, wherein the actuation device (12) moves the carrier (22) in order to move the sliding plate (24).

5. The inert linear shear valve (10) according to any preceding claim, wherein the carrier (22) is disposed between the actuation device (12) and the manifold (14).

6. The inert linear shear valve (10) according to any preceding claim, wherein the at least one resilient member (28, 30) compensates for wear of the sliding plate (24) by maintaining the spring force applied to the sliding plate (24) as the sliding plate (24) wears.

7. The inert linear shear valve (10) according to any preceding claim, wherein the actuation device (12) is a piezoelectric linear actuator, a linear drive actuator, a solenoid actuator, or a pneumatic drive actuator.

8. The inert linear shear valve (10) according to any preceding claim, wherein the manifold (14) is made of a chemically inert ceramic.

9. The inert linear shear valve (10) according to any preceding claim, wherein the manifold (14) has a highly polished top surface.

10. The inert linear shear valve (10) according to any preceding claim, wherein the sliding plate (24) has a highly polished bottom surface.

11. The inert linear shear valve (10) according to any preceding claim, wherein the sliding plate (24) is made of a chemically inert ceramic.

12. The inert linear shear valve (10) according to any preceding claim, wherein the manifold (14) has a first flow passage (16), a second flow passage (18), and a third flow passage (20).

13. The inert linear shear valve (10) according to claim 12, wherein the manifold (14) has a first port (40) connected to the first flow passage (16), a second port (42) connected to the second flow passage (18), and a third port (44) connected to the third flow passage (20).

14. The inert linear shear valve (10) according to claim 13, wherein the first port (40) and the third port (44) serve as inlet ports and the second port (42) serves as an outlet port.

15. The inert linear shear valve (10) according to claim 13 or 14, wherein in the second position the notch (26) in the sliding plate (24) fluidly couples the second port (42) and the third port (44).

16. The inert linear shear valve (10) according to claim 15, wherein the first flow passage (16), the second flow passage (18), and the third flow passage (20) are spaced apart such that the first flow passage (16) and the third flow passage (20) cannot be fluidly connected by the notch (26) in the sliding plate (24).

17. The inert linear shear valve (10) according to any preceding claim, wherein a width (63) of the notch (26) is approximately equal to or less than a sum of a width of a first adjacent flow passage of the plurality of flow passages (16, 18, 20), a width of a second adjacent flow passage of the plurality of flow passages (16, 18, 20) that is adjacent the first adjacent flow passage, and a distance between the first adjacent flow passage and the second adjacent flow passage at a position adjacent the sliding plate (24).

18. The inert linear shear valve (10) according to any preceding claim, wherein when the sliding plate (24) is positioned in a third position none of the plurality of flow passages (16, 18, 20) are fluidly coupled to another of the plurality of flow passages (16, 18, 20).

19. The inert linear shear valve (10) according to any preceding claim, wherein the carrier (22) has a bore (32, 34) that houses each respective resilient member (28, 30).

20. The inert linear shear valve (10) according to any preceding claim in combination with a device manifold (50), wherein the device manifold (50) has a plurality of ports (52, 54, 56) that connect to the plurality of ports (40, 42, 44) on the manifold (14).
